(19) United States
(12) Patent Application Publication
(10) Pub. No.: US 2007/0276072 A1
(43) Pub. Date: Nov. 29, 2007

(54) Method for the Production of Polyester Resins Containing Nanoscale Additives for Coating Powders

(76) Inventors: Thomas Schmidt, Wels (AT); Gerald Hemedinger, Vienna (AT)

Correspondence Address: K.F. ROSS P.C., 5683 RIVERDALE AVENUE, SUITE 203 BOX 900, BRONX, NY, 10471-0900, US

(21) Appl. No.: 10/588,346

(22) PCT Filed: Feb. 4, 2005
(86) PCT No.: PCT/AT05/00036

§ 371 Date: Apr. 19, 2007

(30) Foreign Application Priority Data
Feb. 6, 2004 (AT) A 181/2004

(51) Int. Cl. C08K 3/00; C08L 67/00; C09D 5/03

(52) U.S. Cl. 524/410; 524/408; 524/413; 524/423; 524/430; 524/432; 524/434; 524/439; 524/445; 524/599

(57) ABSTRACT

The present invention relates to a method for the preparation of polyester resins containing nanoscale additives which are nanodispersed as a binding agent for powder paints, wherein the nanoscale additives are introduced in an outer liquid phase into the reaction mixture over the course of the resin synthesis. The invention relates to a method for the preparation of a powder paint formulation based on polyester resins as a binding agent component as well as, optionally, on pigments, fillers and additives which are conventionally used for powder paints, wherein polyester resins are used which contain nanodispersed nanoscale additives. The invention also comprises a powder paint formulation based on polyester resins as a binding agent component as well as, optionally, on pigments, fillers and additives which are conventionally used for powder paints, wherein the powder paint formulation contains nanoscale additives which are contained in the binding agent matrix in a nanodispersed manner.

The present invention relates to a method for the preparation of polyester resins containing nanoscale additives, which are nanodispersed as a binding agent for powder paints. Furthermore, the invention relates to a method for the preparation of a powder paint formulation as well as a powder paint formulation in itself.

Due to the high economic viability of the method as well as the favorable judgment from an environmental protection standpoint; powder paints have come to be widely used in the coating of materials such as metal, glass, ceramic, etc.

In the past, powder paints have made possible a multitude of different binding agent systems, pigments, filers and additives for a tremendous variety of applications. For example, today, decorative coverings, corrosion protection systems, heat-resistant coatings, weatherproof paints on facades and automobiles as well as numerous functional coatings from glossy to matte, smooth to structures finish have long been the state of the art.

With the increasing availability of nanoscale solids—these include those with a characteristic particle size of <1 μm and preferably of <0.1 μm—which, due to their highly specific characteristics profiles, are capable of giving materials containing them a variety of characteristics that had not been achieved previously, it is possible to prepare powder paints with further special characteristics, which had not existed beforehand, and to hence open up completely novel applications for them. Examples of powder paints that contain nanoparticles can be found, for instance, in EP 1 164 159 A1, EP 1 361 257 A1 and WO 02/051922 A2. However, no more specific teaching with respect to the type and form of the distribution of the nanoparticles in the powder paint can be derived from the prior art, which is disclosed in these documents, and these disclosures also do not deal at all with the problem of an irregular and incomplete distribution of the nanoparticles in the powder paint.

For ecological as well as for economic reasons, it is often very desirable to use certain raw materials in as small quantities as possible. The inconspicuousness of the application associated with the use of small amounts of material is frequently the decisive motivation for getting by with minimal quantities of additives.

Nanoscale particles comply with this endeavor quite well. Due to their extremely high specific surface (surface/mass, for example: m²/g), they are highly effective everywhere in which it is desired that they enter into interaction via their surface with the ambient electromagnetic radiation or that they emit, by means of diffusion, a continuous material flow into the matrix surrounding them. In addition, they can be distributed uniformly in other substances down to the submicroscopic range, which leads to a characteristic profile that is more homogeneous by several orders of magnitude in comparison to the distribution of microscopic particles. As a consequence of their particular fineness, they are not only invisible as such—substances that contain them frequently do not even exhibit turbidity and have a transparent appearance. Due to quantum effects, nanoparticles usually possess new and different characteristics than the micro- and bulk materials having the same chemistry.

Nanoparticular titanium dioxide and zinc oxide already absorb in concentrations which have no relevance in terms of color: UV radiation. Coatings to which they are added are able to protect the substrate reliably and—in contrast to organic UV absorbers, which decompose over time—with long-lasting effect from high-energy and materially damaging UV radiation. According to the brochure “NRC Trade Trends,” 2^{nd} edition, October 2002, page 15 of the company Nordmann, Rassmann GmbH, which involves a special ITO called Nano®ITO, nanocrystalline tin-doted indium oxide (ITO) possesses a series of special characteristics such as transparency in conjunction with electrical conductivity, antistatic properties, electromagnetic shielding and adsorption/reflection of thermal radiation. The redispersibility of Nano®ITO can be used for the refining of polymers or paints by being worked in and can provide these with attractive characteristics such as electrical conductivity, antistatic properties or, to a great extent, impermeability for thermal radiation. Nanoscale antimony tin oxide (ATO), vanadium oxide (according to EP 0 795 565 B1) as well as appropriate carbon (C nanotubes, C nanofibers), according to the available product literature, exhibit a similar characteristics profile as Nano®ITO, nanoscale ferrite particles absorb microwaves. Due to their high specific surface area, nanoscale silver particles are capable even in low mass components of emitting a continuous stream of silver ions to the surrounding matrix and providing it with antimicrobial properties in this manner. In contrast to the provision of a powder paint with biocidal agent which, as disclosed in U.S. Pat. No. 5,980,620 A, for example, is provided with an organic biocide which is homogeneously distributed in the matrix of the coating, as for example a polychlorinated aromatic compound as an agent, the extremely fine but heterogeneously distributed nanoscale silver particles guarantee that the biocidal action of the powder coating will last for the lifetime of the coating, since a loss of action due to a migration of the particles to the surface with subsequent loss of action is ruled out, and the particles—as has been shown by long-term studies—are not exhausted even over the course of years. Nanoscale particles zirconium dioxide, silicon dioxide, aluminum oxide, barium sulfate as well as commensurate clay minerals are capable of providing powder paint formulations with a very significantly improved hardness and scratch resistance. By using mixed oxides of the silicon and aluminum, it is possible, through the selection of the ratio between the elements silicon and aluminum, to vary the optical refractive index of the particles in the context of the values for the oxides of pure silicon or aluminum and, in this manner, to bring it into line with those of the ambient synthetic resin matrix. In this way, it is possible to prepare inorganically fortified yet highly transparent masses. These substances, which have been named for the sake of example, are thus capable of providing paint coatings in general and hence also powder coatings with highly esteemed, novel characteristics.

In following the product information for Nano@ITO, the attempt was made to prepare IR-absorbing powder paint material through the addition of Nano®DITO to a powder paint formulation which otherwise corresponded to the prior art. It was expected that, due to the absorption behavior, such a powder paint formulation would be able to be cured particularly quickly and/or under reduced radiant power by means of IR radiation.

To this end, the powder paint materials—binding agent components, pigments, fillers, additives such as flow-control agents and curing accelerators—were mixed very thoroughly together with the Nano®ITO in accordance with the prior art in a high-speed mixer and then extruded; the introduction of the particles into the powder paint was hence done analogously to the method in aforementioned WO 02/051922 A2 referred to as “melt extrusion.” The further operating sequence of the preparation of the powder paint and its application and curing on patterned plates in IR curing equipment went according to the prior art.

Furthermore, in imitation of the method referred to as “melt blending” in the aforementioned document, the attempt was made in a step preceding the abovementioned procedure to improve the introduction of the Nano®ITO into the powder paint by adding it to the polyester resin being used as a binding agent component, which was in melted form at ˜80° C. in a round-bottomed flask, and stirring it in for one hour. After the stirring-in was completed, the resin was poured off in an analogous manner to the teaching of the abovementioned document and processed further.

These experiments showed that, in order to achieve a noticeably pushed IR curing, relatively high quantities of Nano®ITO are required. Moreover, the surfaces of the patterned plates with the coatings in question—regardless of the method used to produce them—exhibited very non-homogenous appearances, which was apparently not able to be influenced through the reduction of the radiant energy used for the curing. Even an increase of the mixing intensity during the preparation of the dry mixture and/or a second extrusion did not bring about any noteworthy improvement of the result. Apparently, the conventional processes of stirring-in, of mechanical pre-mixing and extrusion are poorly suited for distributing nanoparticles, even those which are referred to as “redispersible,” in an expedient manner in powder paints. It can be assumed that nanoscale particles of other chemical compositions as well can only be distributed in an irregular and incomplete manner in powder paint formulations using the method steps according to the prior art.

According to the disclosure of DE 198 57 316 A1, nanoscale inorganic solid particles such as hydroxides or oxides of silicon, aluminum, titanium and the like, which are available in the form of powders, are converted to acid-stabilized sols which are then converted with a mixture of GPTS (=glycidoxypropyltrimethoxysilane) and TEOS (=tetraethoxysilane), a process in which said particles obtain an epoxy-functional hydrolysate coating. These so-called “coated sols” which are manufactured in this manner with superficially modified particles are subsequently mixed with epoxy-functional mono-, oligo- or polymers and are used as a top coat (to be baked) for the powder coating.

The disclosed ultra-acoustic radiation of the particles in a low-viscosity liquid is certainly considerably more efficient for the preparation of a nanodispersed sol than the methods of the three aforementioned documents. The disadvantage of the masses prepared according to the described method consists in the fact that, after the application and baking-in of the powder paint, it requires another coating system in order to produce coatings with scratch-resistance and hardness. It is also disadvantageous that the coating to be additionally applied is a liquid system so that, in addition to equipment for the application of powder paint, more equipment is needed for the application of a liquid system.

It is not feasible to translate the abovementioned method to powder paints since it is not possible to dissolve the powder paint binding agents, which are solid at room temperature, and the abovementioned coating sols together as is the case in the disclosed compositions.

It is a well known fact that nanoparticles that are obtained in powder form agglomerate quite readily. Nanoparticles in such agglomerates are often irreversibly bonded together and can be brought into a nanodispersed state only at considerable expense and effort, if at all, by means of classical methods. Since only solid raw materials can be used in the manufacture of powder paint, it is therefore economically unfeasible to introduce nanoparticles in a nanodispersed manner into powder paints. However, nanoparticles are often produced in liquid media so that nucleation (formation of nuclei) and growth can be controlled with precision. In the liquid phase, the nanoparticles can be prevented from agglomerating, hence producing stable, nanodispersed liquids. However, such liquids cannot be used in the preparation of powder paints according to the prior art.

It is the object of the present invention to make available a method according to which nanoparticulate additives can be introduced—as functional elements—into polyester resins used as binding agents for powder paints and, subsequently, into powder paint formulations in such a manner that they are efficiently distributed and hence make the sparing use of those additives possible. An object of the invention consists, furthermore, in the preparation of powder coatings that present themselves in a uniform manner visually and in terms of their paint-related technical characteristics.

The object relating to the preparation of a commensurate method for the preparation of polyester resins which contain nanodispersed nanoscale additives as a binding agent for powder paints is achieved according to the invention in that the nanoscale additives are introduced in the form of a suspension in a liquid outer phase into the reaction mixture during the course of resin synthesis. According to an especially advantageous modification of this method, a provision is made according to the invention that the nanoscale additives are introduced in the initial phase of resin synthesis.

With this procedural method, it is possible according to the invention to work desired nanoparticles into the polyester resin without the occurrence of agglomerations of same in a simple and very effective manner while avoiding the disadvantages indicated above, so that the nanoparticles are finally contained in the resin as well in nanodispersed distribution. In so doing, the prerequisite is thus met that the nanoscale additives contained in the powder paint develop their respectively innate desired effect in an optimal manner and are hence able to provide the powder paint with the respectively desired characteristic.

Further advantageous features and modifications of the method according to the invention for the preparation of polyester resin containing nanodispersed nanoscale additives as a binding agent for powder paints are characterized in subordinate claims 3 to 24 and follow from the specification and the examples.

The invention relates to a method for the preparation of a powder paint formulation based on polyester resins as a binding agent component as well as, optionally, on pigments, fillers and additives which are conventionally used for powder paints. This method according to the invention is characterized in that polyester resins are used which are prepared using the method according to one of claims 1 to 24 which contain nanodispersed nanoscale additives.

If such polyester resins prepared according to the invention are used for the preparation of powder paints, the possibility arises of providing powder paints with a substantially lower material utilization in an efficient manner with nanoparticles which create functionality, wherein the powder coatings which can be prepared in such a manner a uniform visually and in terms of their paint-related technical characteristics.

The invention also relates to a powder paint formulation based on polyester resins as a binding agent component as well as, optionally, of pigments, fillers and additives which are conventionally used for powder paints, this powder paint formulation being characterized in that it contains nanodispersed nanoscale additives. Only the nanodispersed distribution allows for a maximum utilization of the nano-specific characteristics.

Further advantageous features and modifications of the powder paint formulation according to the invention are characterized in subordinate claims 27 to 39 and follow from the specification and the examples.

Polyester resins as binding agents for powder paints have been the state of the art for decades. In terms of the raw materials used, they are first and foremost carboxyl- and/or hydroxyl-functional and can be used, for example, in combination with polyfunctional epoxide or isocyanate compounds or β-hydroxy alkyl amides as well for the preparation of thermosetting powder coatings. Let DE 2 163 962 A1 be named as an example that discloses thermosetting powder coatings which are based on carboxyl-functional polyesters. Thermosetting powder coatings, which are based on hydroxyl-functional polyesters, are disclosed, for example, in DE 2 105 777 A1.

In addition to these—saturated—polyester resins for thermosetting powder coatings, unsaturated ones are also used for radiation-setting coatings. Let DE 4 432 645 A1 be cited here as an example.

Furthermore, primary-accumulating terminal carboxyl and/or hydroxyl groups can be used during the preparation of the polyester in order to bring about the functionalities named above in the polyester in question by means of the conversion of, for example, epoxide or isocyanate-containing intermediates. Let WO 95/25762 A1 be cited here as an example, which can also be considered as a disclosure for semi-crystalline polyester resins (amorphous polyester resins are predominantly used as binding agents for powder coatings) as well as EP 0 741 763 A1.

The appropriate raw materials and methods for the preparation of polyesters can be derived from the abovementioned documents.

EP 1 236 765 A1 describes the preparation of dispersions with a fluid outer phase containing polymerizable monomers, oligomers and/or polymers, and a disperse phase consisting of nanoscale amorphous silicon dioxide. Particularly dispersions in which—in following the examples—the silicon dioxide particles have been organically modified on their surface through conversion with alkoxy silanes can be used in accordance with the disclosure of this document for the preparation of polymeric materials with high contents of amorphous silicic acid. A high filler content has, as is known, a positive influence in numerous applications on the fracture-mechanical characteristics and the electrical insulation capability of materials. EP 1 236 765 A1 provides no indication regarding how Nano®ITO or other highly specific and efficient nanoparticles can be introduced in a nanodispersed manner into powder paints such that the potential of these particles can be used to the utmost extent possible and, given the often small quantities of these particles that are added, noticeable inhomogeneities of the resulting powder coatings can be avoided.

The flowable outer phase of the dispersions used according to the invention are, in the simplest case, water. Since numerous nanoparticles are produced according to wet-chemical methods in aqueous solutions, water is particularly obvious as an outer phase. The majority of the water added to the reaction mixture with the dispersion exits the reactor as vapor before and partially beginning at the time of initiation of the esterification reaction and thus increases the quantity of the byproduct water which occurs during esterification.

Solvents that behave in a neutral manner toward the synthesis of the polyesters according to the invention are another group of liquids which can be used according to the invention. Examples are aromatic hydrocarbons, low alcohols, ether or even ketones. For ecological as well as economic reasons, however, their use is less preferred. Just as described previously for water, solvents are also removed from the mixture through vaporization.

Furthermore, the flowable outer phase can be liquid substances that are used in any case as reactants during polyester synthesis. Examples for these are diols that are liquid at room temperature such as ethane diol 1,2, propane diol 1,2 and propane diol 1,3, 2-methyl propane diol 1,3, butane diol 1,4, pentane diol 1,5 and 3-methyl pentane diol 1,5. Furthermore, diols or polyols can also be used which are solid at room temperature but are liquid when mixed with water or low alcohol, such as 2,2-dimethyl propane diol 1,3 or cyclohexane dimethanol with water or cyclohexane dimethanol with methanol. Another possibility is represented by the esters of dicarboxylic acids with low alcohols, for example adipic acid dimethyl ester, glutaric acid dimethyl ester or succinic acid dimethyl ester. Even the inner esters of hydroxy carboxylic acids such as ε-caprolacton or γ-butyrolacton are suitable as an outer flowable phase. These reactants—with the exception of the alcoholic components of carboxylic acid esters—are predominantly installed into the emerging resin, so there is hardly a necessity for the vaporization of liquids, which is advantageous with respect to the energy required for the production of resins.

The dispersions which are required for the inventive use of the nanoscale additives can usually be ordered from the manufacturer of these substances and represent the preferred source for nanodispersed preparations. In isolated cases in which this is not possible, suitable dispersions can also be quite successfully prepared by the user in the appropriate liquid phases. Dispersion machines that are suitable for this purpose are, for example, dissolver or pearl mills, optionally in combination with ultrasound. The prior art is described, for example, by A. Goldschmidt/H.-J. Streitberger, BASF-Handbuch Lackiertechnik [BASF Handbook of Paint Technology], Vincentz-Verlag, 2002. Preferably, nanoparticles are prepared and stabilized in a “bottom up” synthesis in a directly nanodispersed manner through nucleation and controlled growth in the liquid phase. In this manner, agglomeration is prevented right from the outset.

The quantities of nanoscale functional elements added to the polyester and hence to the final powder paint vary greatly—they comprise a range of concentration which extends over at least 3 powers of ten and depend primarily on the type of the additive in question and the effect being aspired to.

The following examples are intended to illustrate the utility of the invention is further detail without restricting it to the modifications described here. While it is true that the invention is described in more detail in each case merely on the basis of a polyester formulation and very similar powder paint formulations, it should be noted here that other polyesters and/or powder paint formulations can be used as well without being considered of lesser value.

### COMPARATIVE EXAMPLE A

### Carboxyl Group-Containing Polyester Resin, Not Inventive

In a heatable 2-1 reaction vessel equipped with stirrer, temperature sensor, partial reflux column, distillation bridge and inert gas line (nitrogen), 482.16 g of 2,2-dimethyl propane diol 1,3 and 37.25 g of ethylene glycol were presented and melted under the addition of 20 g water and heating to a maximum of 140° C. under nitrogen atmosphere. Under stirring, 722.70 g of terephthalic acid, 65.76 g of adipic acid as well as 0.1 % of Sn-containing catalysts (with respect to the total quantity of the finished resin) were then added and the temperature of the mass is increased incrementally to 240° C. The reaction was continued at this temperature until no more distillate occurred. Under reduced pressure (a 30 kPa), the reaction was then continued until the acid number of the hydroxy-functional polyester resin was 7 mg KOH/g.

Subsequently, the temperature in the reaction vessel was reduced to 190° C. and 153.70 g of trimellitic acid anhydride were added to the hydroxy-functional polyester. Under stirring, the mixture was maintained at this temperature for 70 minutes and then emptied into a metal collection basin, where it solidified under cooling. The finished resin had a final acid number of 72.6 mg KOH/g polyester resin.

### COMPARATIVE EXAMPLE B

### Carboxyl Group-Containing Polyester Resin, Not inventive

In a heatable 2-1 reaction vessel equipped with stirrer, temperature sensor and inert gas line (nitrogen), 1 146 g of granulated polyester resin according to comparative example A were carefully heated to 180° C. In accordance with the teaching of WO 02/051922 A1 (“melt blending”), 3 g dried, solid Nano®ITO (nanocrystalline tin-doted indium oxide of the company Nanogate Technologies) were added to the resulting melt and stirred for one hour under constant temperature. Subsequently, the mixture was emptied into a metal collection basin, where it solidified under cooling.

### EXAMPLE 1

### Carboxyl Group-Containing Polyester Resin with Nanoscale and Nanodispersed Nano®ITO—Inventive

In the reaction vessel described in comparative example A, the glycols were presented as indicated above and melted under the addition of 20 g water and 1.55 g of a 25% nanodispersed suspension of Nano®ITO in water (Nanogate Technologies) and heated to a maximum of 140° C. under nitrogen atmosphere. The remaining procedure for the preparation of the polyester then continued completely analogously to the comparative example. The finished resin had a final acid number of 72.2 mg KOH/g polyester resin and had a component of 0.03% Nano®ITO.

### EXAMPLE 2

### Carboxyl Group-Containing Polyester Resin with Nanoscale and Nanodispersed Nano®ITO—Inventive

In the reaction vessel described in comparative example A, 482.16 g of 2,2-dimethyl propane diol 1,3 and 36.09 g of ethylene glycol were presented and melted under the addition of 20 g water and 1.55 g of a 25% nanodispersed suspension of Nano®DITO in ethylene glycol (Nanogate Technologies) and heating to a maximum of 140° C. under nitrogen atmosphere. The remaining procedure for the preparation of the polyester then continued completely analogously to comparative example A. The finished resin had a final acid number of 72.5 mg KOH/g polyester resin and had a component of 0.03% Nano®ITO.

### EXAMPLE 3

### Carboxyl group-Containing polyester Resin with Nanoscale and Nanodispersed Carbon (C Nanotubes)—Inventive

In the reaction vessel described in comparative example A, 482.16 g of 2,2-dimethyl propane diol 1,3 and 37.25 g of ethylene glycol were presented and melted under the addition of 38.64 g of a 1% nanodispersed suspension of C nanotubes in water (Nanoledge) and heating to a maximum of 140° C. under nitrogen atmosphere. The remaining procedure for the preparation of the polyester then continued completely analogously to comparative example A. The finished resin had a final acid number of 72.8 mg KOH/g polyester resin and had a component of 0.03% C nanotubes.

### EXAMPLE 4

### Carboxyl group-Containing Polyester Resin with Nanoscale and Nanodispersed Silver/Titanium Dioxide—Inventive

In the reaction vessel described in comparative example A, 482.16 g of 2,2-dimethyl propane diol 1,3 and 37.25 g of ethylene glycol were presented and melted under the addition of 154.54 g of a 20% nanodispersed suspension of silver/titanium dioxide in water (ItN Nanovation GmbH) and heated to a maximum of 140° C. under nitrogen atmosphere. The remaining procedure for the preparation of the polyester then continued completely analogously to comparative example A. The finished resin had a final acid number of 71.0 mg KOH/g polyester resin and had a component of 2.34% C silver/titanium dioxide.

Using these polyester resins—which had been milled to a grain size of about <3 mm—powder paints were prepared according to the following schematic formulation. Comparative examples C, D and E merely contain polyester from comparative examples a and B as a polyester component, and the polyesters from examples 1-4 were used for the formulation of examples 5-8.

Table 1 which follows describes the composition of the powder paint formulations with the letters C, D and E (comparative examples, not inventive) and 5 - 8 (examples, inventive).

TABLE 1

| | Powder paint formulation no. | | | | | | |
|---|---|---|---|---|---|---|---|
| Raw material | C | D | E | 5 | 6 | 7 | 8 |
| Polyester comparative example A | 382.9 | 382.0 | — | — | — | — | — |
| Polyester comparative example B | — | — | 383.0 | | | | |
| Polyester example 1 | — | — | — | 383.0 | — | — | — |
| Polyester example 2 | — | — | — | — | 383.0 | — | — |
| Polyester example 3 | — | — | — | — | — | 383.0 | — |
| Polyester example 4 | — | — | — | — | — | — | 385.0 |
| NANO-ITO (dried, solid)¹ | 0.1 | 1.0 | — | — | — | — | — |
| Araldit GT 6063 | 340.7 | 340.7 | 340.7 | 340.7 | 340.7 | 340.3 | 341.0 |
| Reafree C4705-10 | 25.0 | 25.0 | 25.0 | 25.0 | 25.0 | 25.0 | 25.0 |
| Dyhard MI-C | 3.7 | 3.7 | 3.7 | 3.7 | 3.7 | 3.7 | 3.7 |
| Lanco Wax TF 1830 | 15.0 | 15.0 | 15.0 | 15.0 | 15.0 | 15.0 | 15.0 |
| Tinuvin 144 | 2.0 | 2.0 | 2.0 | 2.0 | 2.0 | 2.0 | 2.0 |
| Bayferrox 3920 | 2.6 | 2.6 | 2.6 | 2.6 | 2.6 | 2.6 | — |
| Titanium Tiona RCL 696 | 197.6 | 197.6 | 197.6 | 197.6 | 197.6 | 197.6 | 61.0 |
| China Clay extra ST, milled | 30.0 | 30.0 | 30.0 | 30.0 | 30.0 | 30.0 | 30.0 |
| Bayferrox 943 | — | — | — | — | — | — | 4.6 |
| Paliotiol [sic, Paliotol]Yellow L 0962 | — | — | — | — | — | — | 8.2 |
| Heliogen Green | — | — | — | — | — | — | 1.0 |
| Hydrocarb 90 | — | — | — | — | — | — | 123.5 |

¹Nanocrystalline tin-doted indium oxide of the company Nanogate Technologies
Indicated figures: quantities of raw materials in grams

The mixtures of formulations C, D and E above (comparative examples C, D and E) as well as 5 - 8 were mixed in a Prism Pilot 3 laboratory mixer for one minute at 1500 RPM and then extruded on a laboratory extruder of the type Theysohn TSK PCE 20/24D (zone temperatures 40/60/80/80° C.) at 400 RPM. Subsequently, the extrudates obtained were broken and milled to a grain fineness of <100 μm.

The thusly-obtained powder paints—with the exception of example 8—were applied using Gema Easy Tronic coating equipment on test plates of MDF (final layer thickness approx. 80 μm). The formulation according to example 8 was applied instead to test plates of aluminum. Then the test plates with formulations C-E and 5-7 were subjected to curing by means of medium- and long-wave IR radiation in electrically operated curing equipment—4 radiators of the Heraeus Co. (2 medium-wave carbon radiators, 2 conventional medium-wave radiators), both mounted perpendicularly to the direction of conveyance and having a maximum temperature of <I 000° C.

The conveyor speed was selected such that the samples passed over the curing segment in around 3.5 minutes. For the first 30 seconds, the surface temperature lay at approx. 100° C., then at an average of 135° C.

A visual inspection of the test plates with formulations C and, particularly, D and E turned up a strongly inhomogeneous surface appearance with needle pricks and contamination. The formulations according to the invention 5-7 made a uniform optical impression.

Table 2 which follows describes the chemical resistance of the probands in question against the effect of a solvent (methyl ethyl ketone). The feature of chemical resistance can be used in order to evaluate the cross-linking density of the powder paint achieved through the baking-in.

TABLE 2

| Powder paint formulation no. | Chemical resistance [min] |
|---|---|
| C | <1 |
| D | 1 |
| E | 2 |
| 5 | >10 |
| 6 | >10 |
| 7 | >10 |

Execution: At room temperature, methyl ethyl ketone is dripped onto the surface to be tested and the time is measured in minutes after which the paint can be wiped away at least partially from the substrate with a cellulose cloth under moderate pressure. If the powder paint withstands the solvent for 10 minutes, the test is terminated and the test is considered to have been passed.

In comparative example C (the addition of 0.01% Nano®ITO was not done according to the invention), no curing is achieved through the thermal treatment in the curing equipment (the powder paint can be washed off). An increased of the quantity added in D by a factor of ten (0.1% Nano®ITO in the powder paint) in comparison to comparative example C as well as in comparison to examples 5 and 6 according to the invention brings about a marginal but still completely insufficient curing. Comparative example E—also containing 0.1% Nano®ITO in the powder paint as in comparative example C—exhibits a trend towards improvement in comparison to this, but there is no curing to speak of even here.

The test plates with powder paint formulation no. 8—containing carboxyl group-containing polyester resin with nanoscale and nanodispersed silver/titanium dioxide—were baked in a convection oven for 10 minutes at 150° C. The antimicrobial effect (bacteria, fungi, yeasts) of the coating made of the formulation above has been confirmed by the Fresenius Institute (Taunusstein, Hesse) following ASTM Standard E2180.

### EXAMPLE 9

### Carboxyl Group-Containing Polyester Resin with Nanoscale and Nanodispersed Ferrite (Fe₃O₄)—Inventive

In the reaction vessel described in the comparative example, 482.16 g of 2,2-dimethyl propane diol 1,3 and 37.25 g of ethylene glycol were presented and melted under the addition of 53.27 g of a 11 % nanodispersed suspension of nanoscale ferrite (Fe₃O₄) in water (Caesar Institut, Bonn) and heating to a maximum of 140° C. under nitrogen atmosphere. The remaining procedure for the preparation of the polyester then continued completely analogously to comparative example A. The finished resin had a final acid number of 71.3 mg KOH/g polyester resin and had a component of 0.45% Fe₃O₄.

Using this polyester resin—which had been reduced to a grain size of approx. <3 mm—were prepared according to the following schematic formulation. Table 3 which follows describes the composition of the powder paint formulations according to the invention with numbers 10-12.

TABLE 3

| | Powder paint formulation no. | | |
|---|---|---|---|
| Raw material | 10 | 11 | 12 |
| Polyester comparative example 1 | — | 203.7 | 387.0 |
| Polyester example 9 | 407.4 | 203.7 | 20.4 |
| Araldit GT 7220 | 271.6 | 271.6 | 271.6 |
| Dyhard MI-C | 6.0 | 6.0 | 6.0 |
| Lanco Wax TF 1830 | 15.0 | 15.0 | 15.0 |
| Titanium dioxide Kronos 2310 | 300.0 | 300.0 | 300.0 |

Indicated figures: quantities of raw materials in grams

1. Method for the preparation of polyester resins containing nanodispersed nanoscale additives as binding agents for powder paints, characterized in that the nanoscale additives are introduced in the form of a suspension in a liquid outer phase into the reaction mixture over the course of resin synthesis.

2. Method according to claim 1, characterized in that the nanoscale additives are introduced in the initial phase of the resin synthesis.

3. Method according to claim 1 or 2, characterized in that the outer liquid phase is water.

4. Method according to claim 1 or 2, characterized in that the outer liquid phase is solvents which behave neutrally to the synthesis of the polyester resins, such as aromatic hydrocarbons, low alcohols, ethers or ketones, for example.

5. Method according to claim 1 or 2, characterized in that the outer liquid phase is reactants which are used during the polyester synthesis.

6. Method according to claim 5, characterized in that the outer liquid phase is diols which are liquid at room temperature, such as ethanol 1,2, propane diol 1,2, propane diol 1,3, 2-methyl propane diol 1,3, butane diol 1,4, pentane diol 1,5, 3-methyl pentane diol 1,5.

7. Method according to claim 5, characterized in that the outer liquid phase is diols or polyols which are mixed with water or low alcohols.

8. Method according to claim 7, characterized in that the outer liquid phase is 2,2-dimethyl propane diol 1,3 or cyclohexane dimethanol which is mixed with water.

9. Method according to claim 7, characterized in that the outer liquid phase is cyclohexane dimethanol which is mixed with methanol.

10. Method according to claim 5, characterized in that the outer liquid phase is esters of dicarboxylic acids with low alcohols such as adipic acid dimethyl ester, glutaric acid dimethyl ester or succinic acid dimethyl ester.

11. Method according to claim 5, characterized in that the outer liquid phase is the inner esters of hydroxy carboxylic acids such as ε-caprolacton or γ-butyrolacton.

12. Method according to one of claims 1 to 11, characterized in that nanocrystalline tin-doted indium oxide (nano indium tin oxide) is used as a nanoscale additive.

13. Method according to one of claims 1 to 11, characterized in that antimony tin oxide and/or vanadium oxide is used as a nanoscale additive.

14. Method according to one of claims 1 to 11, characterized in that C nanotubes or C nanofibers are used as nanoscale additives.

15. Method according to one of claims 1 to 11, characterized in that ferrite particles are used as a nanoscale additive.

16. Method according to one of claims 1 to 11, characterized in that silver particles are used as a nanoscale additive.

17. Method according to one of claims 1 to 11, characterized in that silver/titanium dioxide is used as a nanoscale additive.

18. Method according to one of claims 1 to 11, characterized in that titanium dioxide is used as a nanoscale additive.

19. Method according to one of claims 1 to 11, characterized in that zinc oxide is used as a nanoscale additive.

20. Method according to one of claims 1 to 11, characterized in that zirconium dioxide is used as a nanoscale additive.

21. Method according to one of claims 1 to 11, characterized in that silicon dioxide is used as a nanoscale additive.

22. Method according to one of claims 1 to 11, characterized in that aluminum oxide is used as a nanoscale additive.

23. Method according to one of claims 1 to 11, characterized in that barium sulfate is used as a nanoscale additive.

24. Method according to one of claims 1 to 11, characterized in that clay minerals are used as nanoscale additives.

25. Method for the preparation of a powder paint formulation based on polyester resins as a binding agent component as well as, optionally, on pigments, fillers and additives which are conventionally used for powder paints, characterized in that polyester resins are used which are prepared using the method according to one of claims 1 to 24 which contain nanodispersed nanoscale additives.

26. Powder paint formulation based on polyester resins as a binding agent component as well as, optionally, on pigments, fillers and additives which are conventionally used for powder paints, wherein the powder paint formulation contains nanoscale additives, characterized in that the nanoscale additives are contained in the binding agent matrix of the powder paint formulation in a nanodispersed manner.

27. Powder paint formulation according to claim 26, characterized in that it contains nanocrystalline tin-doted indium oxide (nano indium tin oxide).

28. Powder paint formulation according to claim 26, characterized in that it contains antimony oxide and/or vanadium oxide as a nanoscale additive.

29. Powder paint formulation according to claim 26, characterized in that it contains C nanotubes or C nanofibers as nanoscale additives.

30. Powder paint formulation according to claim 26, characterized in that it contains ferrite particles as a nanoscale additive.

31. Powder paint formulation according to claim 26, characterized in that it contains silver particles as a nanoscale additive.

32. Powder paint formulation according to claim 26, characterized in that it contains silver/titanium dioxide as a nanoscale additive.

33. Powder paint formulation according to claim 26, characterized in that it contains zirconium dioxide as a nanoscale additive.

34. Powder paint formulation according to claim 26, characterized in that it contains silicon dioxide as a nanoscale additive.

35. Powder paint formulation according to claim 26, characterized in that it contains aluminum oxide as a nanoscale additive.

36. Powder paint formulation according to claim 26, characterized in that it contains titanium dioxide as a nanoscale additive.

37. Powder paint formulation according to claim 26, characterized in that it contains barium sulfate as a nanoscale additive.

38. Powder paint formulation according to claim 26, characterized in that it contains clay minerals as nanoscale additives.

39. Powder paint formulation according to claim 26, characterized in that it contains zinc oxide as a nanoscale additive.
